(19) United States
(12) Patent Application Publication
(10) Pub. No.: US 2011/0175980 A1
(43) Pub. Date: Jul. 21, 2011

(54) SIGNAL PROCESSING DEVICE

(75) Inventor: Ryogo YANAGISAWA, Osaka (JP)

(73) Assignee: PANASONIC CORPORATION, OSAKA (JP)

(21) Appl. No.: 13/033,138

(22) Filed: Feb. 23, 2011

Related U.S. Application Data
(63) Continuation of application No. PCT/JP2009/001669, filed on Apr. 10, 2009.

(30) Foreign Application Priority Data
Oct. 31, 2008 (JP) 2008-281970

(51) Int. Cl. H04N 13/00

(52) U.S. Cl. 348/43; 348/E13.064

(57) ABSTRACT

In a signal processing device, a first left eye noise extraction circuit and a first right eye noise extraction circuit perform the same noise extraction process. A second left eye noise extraction circuit and a second right eye noise extraction circuit perform different noise extraction processes. The signal processing control circuit controls a selector so that the selector selects the outputs of the left eye noise extraction circuits for a left eye video signal, and the outputs of the right eye noise extraction circuits for a right eye video signal. The correlation detection circuit detects a correlation between the left and right eye video signals, and controls a selector so that the selector selects the output of the first left or right eye noise extraction circuit when the correlation is high, and the output of the second left or right eye noise extraction circuit when the correlation is low.

### CROSS-REFERENCE TO RELATED APPLICATIONS

This is a continuation of PCT International Application PCT/JP2009/001669 filed on Apr. 10, 2009, which claims priority to Japanese Patent Application No. 2008-281970 filed on Oct. 31, 2008. The disclosures of these applications including the specifications, the drawings, and the claims are hereby incorporated by reference in their entirety.

### BACKGROUND

The present disclosure relates to signal processing for providing stereoscopic display using an image for a left eye and an image for a right eye.

Conventionally, there are well known techniques of allowing the viewer to recognize a stereoscopic image using a left eye image and a right eye image. Japanese Patent Publication No. S61-227498 describes a method of preparing a left eye image and a right eye image and using special glasses to allow stereoscopic viewing.

FIG. 20 is a block diagram showing an example of a conventional configuration. In FIG. 20, the configuration includes a display 201, a drive circuit 202, stereoscopic glasses 203, a stereoscopic video signal input terminal 204, and a stereoscopic display device 205. Examples of the display 201 include a plasma display, a liquid crystal display, etc.

A stereoscopic video signal including video signals for a left eye and video signals for a right eye is input through the stereoscopic video signal input terminal 204. For example, in the stereoscopic video signal, the left eye video signals and the right eye video signals are multiplexed (alternately arranged or transmitted) on a field-by-field basis. The drive circuit 202 extracts from the stereoscopic video signal a drive signal for distinguishing the left eye video signals and the right eye video signals.

FIG. 21 shows the relationship between the stereoscopic video signal, and the left eye video signal, the right eye video signal, and the drive signal. The drive signal is, for example, a signal which is zero (0) when the left eye video signal is presented, and one (1) when the right eye video signal is presented. For example, if the left eye video signals are provided in even-numbered fields and the right eye video signals are provided in odd-numbered fields, the drive signal can be obtained by checking the fields of the stereoscopic video signal.

The stereoscopic glasses 203 have, for example, liquid crystal shutters at portions where lenses are provided in normal glasses. The liquid crystal shutters are switched on and off based on the drive signal. Specifically, when the left eye video signal is received, the left eye liquid crystal shutter is in the transmissive state and the right eye liquid crystal shutter is in the non-transmissive state. In other words, the left eye video signal is viewed by the left eye. Conversely, when the right eye video signal is received, the right eye liquid crystal shutter is in the transmissive state and the left eye liquid crystal shutter is in the non-transmissive state. In other words, the right eye video signal is viewed by the right eye.

For example, as shown in FIG. 21, left eye images based on the left eye video signals and right eye images based on the right eye video signals are alternately displayed on a field-by-field basis on the display 201. The left eye images are viewed only by the left eye and the right eye images are viewed only by the right eye. The left and right eye images differ in their positions by a distance corresponding to a binocular parallax between the left eye and the right eye. By combining the display 201 with the stereoscopic glasses 203, the resultant image appears solid (three-dimensional) to the viewer.

### SUMMARY

The aforementioned conventional device can be used to provide stereoscopic video. In recent years, however, AV apparatuses have been rapidly advanced, and therefore, there is always a demand for a technique of further improving image quality.

Image quality is conventionally improved by the following known techniques: a noise component is reduced (hereinafter referred to noise reduction); a resolution, a detail, and a sharpness which the viewer perceives are improved to clearly display details (hereinafter referred to as enhancement); etc. A problem has, however, been newly found that if a stereoscopic video signal is subjected to signal processing, such as the noise reduction, the enhancement, etc., a mismatch occurs between left and right eye images, thereby reducing rather than improving image quality.

For example, in FIG. 21, even if the noise reduction, the enhancement, etc. is applied to a point (L1, R1) which does not cause a binocular parallax, the above problem does not arise. If, however, the noise reduction, the enhancement, etc. is applied to a point which causes a binocular parallax (e.g., a point (L2, R2 of FIG. 21) which causes stereoscopic depth perception, or a point which is hidden from the left eye and is viewed by the right eye), a mismatch occurs between left and right eye images, so that, disadvantageously, perceived noise increases or stereoscopic perception is lost.

The present disclosure describes implementations of a signal processing device which can correctly apply a signal process, such as the noise reduction, the enhancement, etc. to stereoscopic video signals.

According to the present disclosure, in a signal processing device for processing a stereoscopic video signal including a left eye video signal and a right eye video signal, different signal processes are applied to the left and right eye video signals, or no signal process is applied to a region where a mismatch is likely to occur.

Specifically, an example signal processing device of the present disclosure is a signal processing device for processing a stereoscopic video signal including a left eye video signal and a right eye video signal, including a signal processing controller configured to output a control signal including a timing at which the left eye video signal of the stereoscopic video signal is processed and a timing at which the right eye video signal of the stereoscopic video signal is processed, and a signal processor configured to apply different signal processes to the left and right eye video signals based on the control signal of the signal processing controller.

In the example signal processing device, the signal processor includes a left eye noise reducer configured to reduce a noise component of the left eye video signal, and a right eye noise reducer configured to reduce a noise component of the right eye video signal.

In the example signal processing device, the signal processor includes a left eye enhancer configured to enhance a predetermined signal component of the left eye video signal, and a right eye enhancer configured to enhance a predetermined signal component of the right eye video signal.

Another example signal processing device of the present disclosure is a signal processing device for processing a stereoscopic video signal including a left eye video signal and a right eye video signal, including a signal processing controller configured to output a control signal including a timing at which the left eye video signal of the stereoscopic video signal is processed and a timing at which the right eye video signal of the stereoscopic video signal are processed, a correlation detector configured to detect a correlation between the left and right eye video signals and output a result of the detection, and a signal processor configured to apply different signal processes to the left and right eye video signals based on the control signal of the signal processing controller and the detection result of the correlation detector.

In the example signal processing device, the correlation detector delays one of the left and right eye video signals by a predetermined period of time and calculates a difference between the delayed one of the left and right eye video signals and the other of the left and right eye video signals to detect a correlation between the left and right eye video signals, and outputs the result of the detection.

In the example signal processing device, the signal processor includes a left eye noise reducer configured to reduce a noise component of the left eye video signal, and a right eye noise reducer configured to reduce a noise component of the right eye video signal.

In the example signal processing device, the signal processor includes a left eye enhancer configured to enhance a predetermined signal component of the left eye video signal, and a right eye enhancer configured to enhance a predetermined signal component of the right eye video signal.

In the example signal processing device, the signal processor applies a first signal process to the left and right eye video signals in a region where the correlation detector has detected a high correlation, and applies a second signal process to the left and right eye video signals in a region where the correlation detector has not detected a high correlation.

In the example signal processing device, the signal processor includes a first left eye noise reducer configured to reduce a noise component of the left eye video signal in a region where the correlation detector has detected a high correlation, a first right eye noise reducer configured to reduce a noise component of the right eye video signal in a region where the correlation detector has detected a high correlation, a second left eye noise reducer configured to reduce a noise component of the left eye video signal in a region where the correlation detector has not detected a high correlation, and a second right eye noise reducer configured to reduce a noise component of the right eye video signal in a region where the correlation detector has not detected a high correlation.

In the example signal processing device, the signal processor includes a first left eye enhancer configured to enhance a predetermined signal component of the left eye video signal in a region where the correlation detector has detected a high correlation, a first right eye enhancer configured to enhance a predetermined signal component of the right eye video signal in a region where the correlation detector has detected a high correlation, a second left eye enhancer configured to enhance a predetermined signal component of the left eye video signal in a region where the correlation detector has not detected a high correlation, and a second right eye enhancer configured to enhance a predetermined signal component of the right eye video signal in a region where the correlation detector has not detected a high correlation.

Another example signal processing device of the present disclosure is a signal processing device for processing a stereoscopic video signal including a left eye video signal and a right eye video signal, including a correlation detector configured to detect a correlation between the left and right eye video signals and output a result of the detection, and a signal processor configured to apply a signal process to the left and right eye video signals in a region where the correlation detector has detected a high correlation between the left and right eye video signals, and not to apply a signal process to the left and right eye video signals in a region where the correlation detector has not detected a high correlation between the left and right eye video signals.

In the example signal processing device, the correlation detector delays one of the left and right eye video signals by a predetermined period of time and calculates a difference between the delayed one of the left and right eye video signals and the other of the left and right eye video signals to detect a correlation between the left and right eye video signals, and outputs the result of the detection.

In the example signal processing device, the signal processor includes a left eye noise reducer configured to reduce a noise component of the left eye video signal in a region where the correlation detector has detected a high correlation, and a right eye noise reducer configured to reduce a noise component of the right eye video signal in a region where the correlation detector has detected a high correlation.

In the example signal processing device, the signal processor includes a left eye enhancer configured to enhance a predetermined signal component of the left eye video signal in a region where the correlation detector has detected a high correlation, and a right eye enhancer configured to enhance a predetermined signal component of the right eye video signal in a region where the correlation detector has detected a high correlation.

Thus, in the present disclosure, when a left eye video signal or a right eye video signal is processed or when there is a low correlation between a left eye video signal and a right eye video signal, optimized signal processes are applied to the left and right eye video signals separately, or no signal process is applied to a region where a mismatch is likely to occur. Therefore, a mismatch between a left eye image and a right eye image can be reduced or prevented, and therefore, stereoscopic perception is not impaired.

As described above, according to the signal processing device of the present disclosure, optimized signal processes are applied to a left eye video signal and a right eye video signal separately, or no signal process is applied to a region where a mismatch is likely to occur, whereby a mismatch between a left eye image and a right eye image is reduced or prevented, and therefore, stereoscopic perception is not impaired. As a result, a stereoscopic video signal can be correctly processed to provide stereoscopic display with high image quality.

### BRIEF DESCRIPTION OF THE DRAWINGS

FIG. 1 is a block diagram showing an entire configuration of a signal processing device according to a first embodiment of the present disclosure.

FIG. 2A is a diagram for describing a stereoscopic video signal in which left and right eye video signals are multiplexed on a field-by-field basis.

FIG. 2B is a diagram for describing a stereoscopic video signal in which left and right eye video signals are multiplexed on a line-by-line basis.

FIG. 2C is a diagram for describing a stereoscopic video signal in which left and right eye video signals are multiplexed on a pixel-by-pixel basis.

FIG. 3 is a block diagram showing an example internal configuration of a signal processing circuit included in the signal processing device.

FIG. 4 is a block diagram showing a specific example configuration of a noise reduction circuit included in the signal processing circuit.

FIG. 5 is a block diagram showing another specific example configuration of the noise reduction circuit.

FIG. 6 is a block diagram showing still another specific example configuration of the noise reduction circuit.

FIG. 7 is a block diagram showing another example internal configuration of the signal processing circuit.

FIG. 8 is a block diagram showing a specific example configuration of an enhancement circuit included in the signal processing circuit.

FIG. 9 is a block diagram showing another specific example configuration of the enhancement circuit.

FIG. 10 is a block diagram showing still another specific example configuration of the enhancement circuit.

FIG. 11 is a block diagram showing still another example internal configuration of the signal processing circuit.

FIG. 12 is a block diagram showing an entire configuration of a signal processing device according to a second embodiment of the present disclosure.

FIG. 13 is a block diagram showing a specific example configuration of a noise reduction circuit which is a signal processing circuit included in the signal processing device.

FIG. 14 is a block diagram showing a specific example configuration of a correlation detection circuit included in the signal processing device.

FIG. 15 is a block diagram showing another example internal configuration of the signal processing circuit.

FIG. 16 is a block diagram showing a specific example configuration of an enhancement circuit included in the signal processing circuit.

FIG. 17 is a block diagram showing still another example internal configuration of the signal processing circuit.

FIG. 18 is a block diagram showing an entire configuration of a signal processing device according to a third embodiment of the present disclosure.

FIG. 19 is a block diagram showing another entire configuration of the signal processing device.

FIG. 20 is a diagram showing a configuration of a conventional stereoscopic display device.

FIG. 21 is a diagram for describing a stereoscopic video signal.

### DETAILED DESCRIPTION

Embodiments of the present disclosure will be described hereinafter with reference to the accompanying drawings.

### First Embodiment

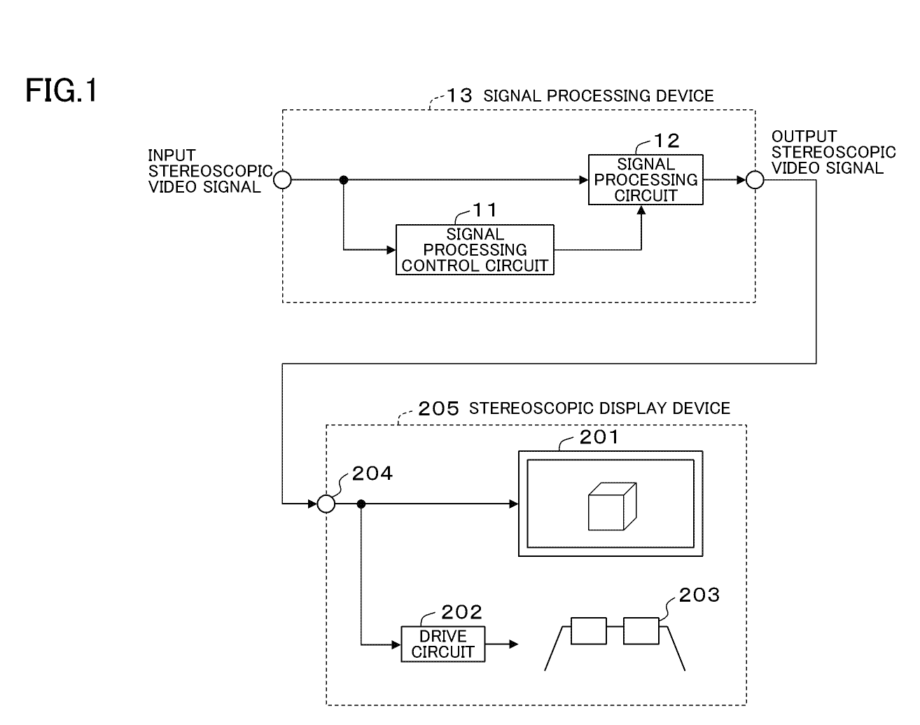

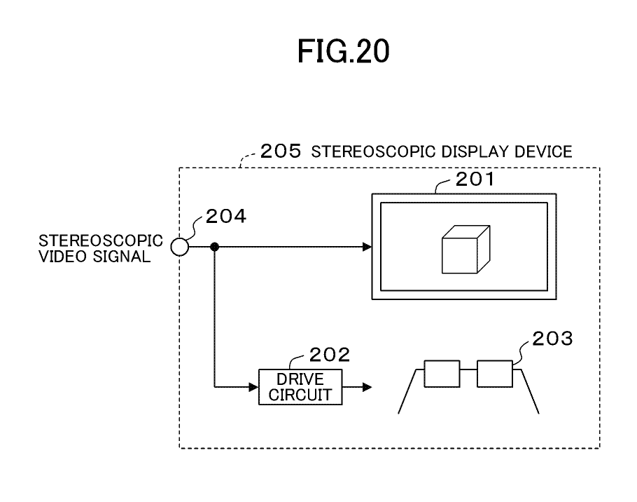

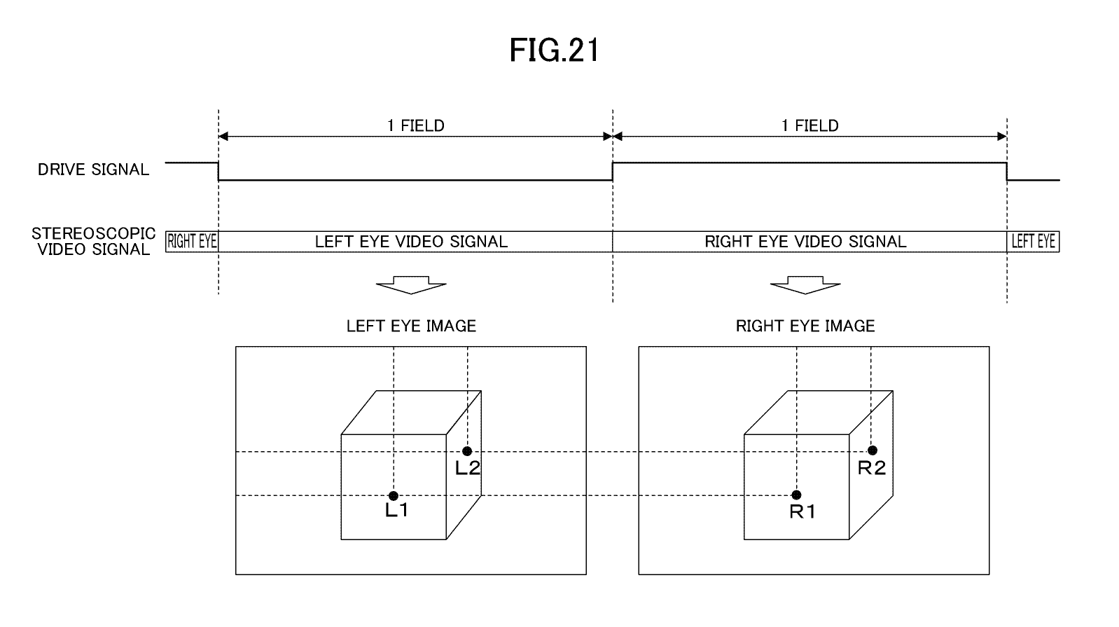

FIG. 1 is a block diagram showing a configuration of a signal processing device according to a first embodiment of the present disclosure. The signal processing device 13 of FIG. 1 includes a signal processing control circuit 11 and a signal processing circuit 12. The stereoscopic display device 205 described in the above BACKGROUND section is connected to the signal processing device 13. Parts which perform the same operations as those of parts of FIG. 20 are indicated by the same reference characters. The stereoscopic display device 205 described in the above BACKGROUND section will not be described in detail.

The stereoscopic display device 205 (except for the stereoscopic glasses 203) and the signal processing device 13 are typically accommodated in a single housing, such as a plasma television or a liquid crystal television. Alternatively, the stereoscopic display device 205 (except for the stereoscopic glasses 203) is accommodated in a single housing, such as a plasma television or a liquid crystal television, and the signal processing device 13 is accommodated in another single housing, such as a DVD player or a DVD recorder. In this case, the stereoscopic display device 205 and the signal processing device 13 are connected to each other via a digital interface, such as the digital visual interface (DVI) or the high-definition multimedia interface (HDMI).

In the configuration of FIG. 1, the signal processing control circuit (signal processing controller) 11 generates a signal indicating timings at which signal processing is applied to left eye video signals, and a signal indicating timings at which signal processing is applied to right eye video signals, to control the signal processing circuit 12. Based on the timings, the signal processing circuit (signal processor) 12 processes left and right eye video signals separately.

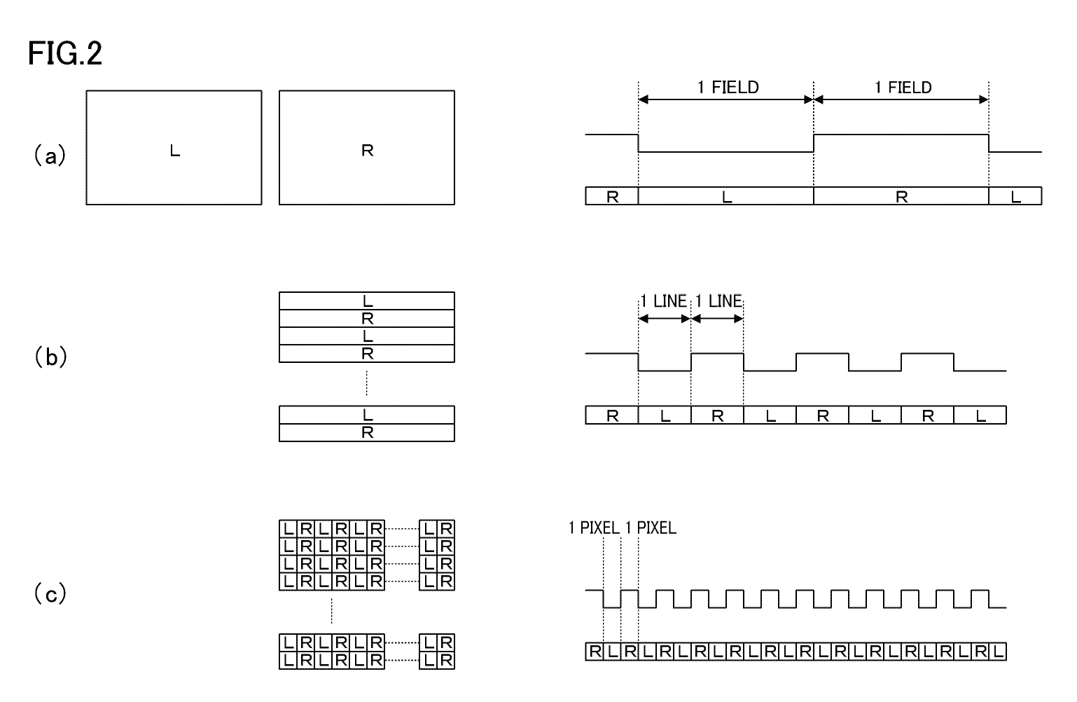

An input stereoscopic video signal includes left and right eye video signals, which are multiplexed. The left and right eye video signals are multiplexed in various previously proposed manners. The left and right eye video signals are typically multiplexed on a field-by-field, line-by-line, or bit-by-bit basis as shown in FIGS. 2A-2C.

FIG. 2A shows an example in which the left eye video signals (L) and the right eye video signals (R) are multiplexed on a field-by-field basis. The signal processing control circuit 11 outputs a control signal which is zero (0) for the fields containing the left eye video signals (L) of the input stereoscopic video signal and one (1) for the fields containing the right eye video signals (R) of the input stereoscopic video signal. For example, if the left and right eye video signals are multiplexed in even-numbered and odd-numbered fields, respectively, the signal processing control circuit 11 can obtain such a control signal by determining whether the current field of the stereoscopic video signal is an even-numbered field or an odd-numbered field. Alternatively, a signal for distinguishing a left eye video signal (L) from a right eye video signal (R) may be multiplexed into the input stereoscopic video signal during vertical flyback periods, and the signal processing control circuit 11 may extract this signal so as to produce the control signal.

FIG. 2B shows an example in which the left eye video signals (L) and the right eye video signals (R) are multiplexed on a line-by-line basis. The signal processing control circuit 11 outputs a control signal which is zero (0) for the lines containing the left eye video signals (L) of the input stereoscopic video signal and one (1) for the lines containing the right eye video signals (R) of the input stereoscopic video signal. For example, if the left and right eye video signals are multiplexed in odd-numbered lines and even-numbered lines, respectively, such a control signal can be obtained by the signal processing control circuit 11 determining whether the current line of the stereoscopic video signal is an odd-numbered line or an even-numbered line. Alternatively, a signal for distinguishing a left eye video signal (L) from a right eye video signal (R) may be multiplexed into the input stereoscopic video signal during horizontal flyback periods, and the signal processing control circuit 11 may extract this signal so as to produce the control signal.

FIG. 2C shows an example in which the left eye video signals (L) and the right eye video signals (R) are multiplexed on a pixel-by-pixel basis. The signal processing control circuit 11 outputs a control signal which is zero (0) for the pixels containing the left eye video signals (L) of the input stereoscopic video signal and one (1) for the pixels containing the right eye video signals (R) of the input stereoscopic video signal. For example, if the left and right eye video signals are multiplexed in odd-numbered and even-numbered pixels, respectively, such a control signal can be obtained by the signal processing control circuit 11 determining whether the current pixel of the stereoscopic video signal is an odd-numbered pixel or an even-numbered pixel.

In the above BACKGROUND section, the operation of the stereoscopic display device 205 has been described, assuming that the left and right eye video signals are multiplexed on a field-by-field basis as shown in FIG. 2A. Similarly, in the cases of FIGS. 2B and 2C, left eye images and right eye images are alternately displayed on the display 201 and are viewed using the stereoscopic glasses 203. Note that, because the left and right eye video signals are multiplexed on a line-by-line basis in the case of FIG. 2B and on a pixel-by-pixel basis in FIG. 2C, the cases of FIGS. 2B and 2C are different from the case of FIG. 2A in that a memory for storing data corresponding to one screen is prepared, and a left or right eye image is reconstructed using the memory before being displayed.

In addition to the cases of FIGS. 2A, 2B, and 2C, for example, the left and right eye video signals may be multiplexed on a frame-by-frame basis, or may be alternately transmitted in the left half and the right half of each line. In any case, the signal processing control circuit 11 generates and outputs a control signal which can be used to distinguish the left eye video signals from the right eye video signals.

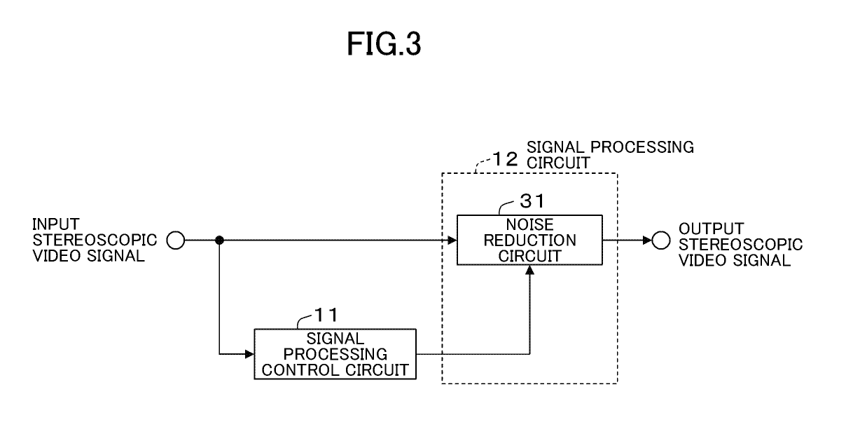

FIG. 3 shows a specific example of the signal processing circuit 12. As shown in FIG. 3, the signal processing circuit 12 includes a noise reduction circuit 31 which is used to reduce noise.

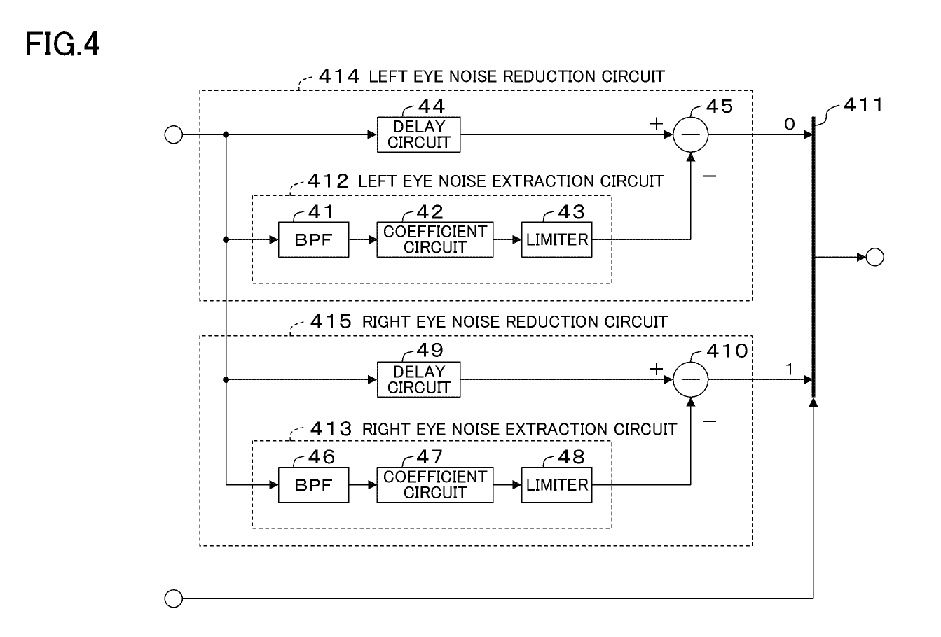

The noise reduction circuit 31 receives the control signal from the signal processing control circuit 11, and applies different noise reduction processes to the left and right eye video signals. FIG. 4 shows a specific example configuration of the noise reduction circuit 31. As shown in FIG. 4, the noise reduction circuit 31 includes band-pass filters (hereinafter referred to as BPFs) 41 and 46, coefficient circuits 42 and 47, limiters 43 and 48, delay circuits 44 and 49, subtractors 45 and 410, a selector 411, a left eye noise extraction circuit 412, a right eye noise extraction circuit 413, a left eye noise reduction circuit (left eye noise reducer) 414, and a right eye noise reduction circuit (right eye noise reducer) 415.

The BPF 41 passes a frequency band of the left eye video signals which is determined based on a noise band of the left eye video signals. For example, when required to extract low-frequency noise, the BPF 41 serves as a low-pass filter. Conversely, when required to extract high-frequency noise, the BPF 41 serves as a high-pass filter. When required to extract noise having frequencies in the vicinity of 3-4 MHz, which is visually noticeable, the BPF 41 serves as a band-pass filter having a peak in the vicinity of 3-4 MHz. In any case, the frequency characteristics of the BPF 41 are determined based on a noise band of the left eye video signals.

The coefficient circuit 42 multiplies the output of the BPF 41 by a constant to determine the amount of noise to be extracted. The constant, which is typically one or less, is used to determine the percentage of the noise extracted by the BPF 41 which is considered as noise. The limiter 43 sets the upper limit of the amount of noise to be extracted so that noise larger than a predetermined value is processed as a signal. By combining the coefficient circuit 42 and the limiter 43, only a noise component can be advantageously extracted while leaving necessary signals.

The delay circuit 44 delays the input stereoscopic video signal by the same time as the process delay time of the left eye noise extraction circuit 412, so that the noise component extracted from the input stereoscopic video signal is subtracted from the input stereoscopic video signal by the subtractor 45 with appropriate timing. In other words, the noise component of the left eye video signal is reduced.

The BPF 46, the coefficient circuit 47, and the limiter 48 of the right eye noise extraction circuit 413, the delay circuit 49, and the subtractor 410 perform the same operations as those of the BPF 41, the coefficient circuit 42, the limiter 43, the delay circuit 44, and the subtractor 45. Note that the band of the BPF 46, the constant of the coefficient circuit 47, and the upper limit of the limiter 48 are optimized for the right eye video signals, i.e., are different from those of the left eye noise extraction circuit 412.

Thus, the left eye noise reduction circuit 414 is optimized for the left eye to reduce a noise component, and the right eye noise reduction circuit 415 is optimized for the right eye to reduce a noise component. The selector 411 selects and outputs the output of the left eye noise reduction circuit 414 for the left eye video signals, and the output of the right eye noise reduction circuit 415 for the right eye video signals, based on the control signal from the signal processing control circuit 11. In other words, the noise component of the input stereoscopic video signal is reduced, and the amount of the reduction is optimized for the left and right eye video signals separately.

As described above, by providing the noise reduction circuit 31 in the signal processing circuit 12, the noise component can be reduced while the amount of the reduction is optimized for the left and right eye video signals separately. For example, if noise is more reduced for one of the left and right eyes of the viewer that has better eyesight than that of the other, noise perceived by the left and right eyes can be balanced, thereby improving stereoscopic perception.

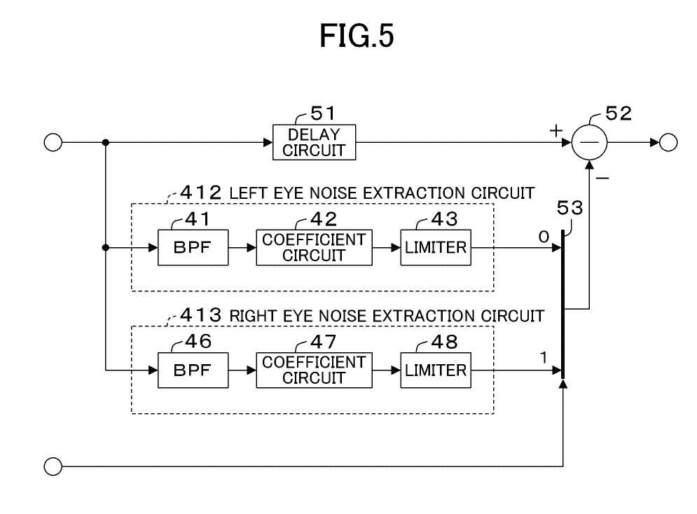

The configuration of FIG. 4 may be modified to that of FIG. 5. In FIG. 5, a reference character 51 indicates a delay circuit, a reference character 52 indicates a subtractor, and a reference character 53 indicates a selector. Parts which perform the same operations as those of parts of FIG. 4 are indicated by the same reference characters. In the configuration of FIG. 5, the delay circuit 51 serves as both of the delay circuits 44 and 49 of FIG. 4, and the subtractor 52 serves as both of the subtractors 45 and 410 of FIG. 4. Such a configuration has a smaller circuit size than that of FIG. 4, and therefore, the signal processing circuit 12 can be manufactured at lower cost.

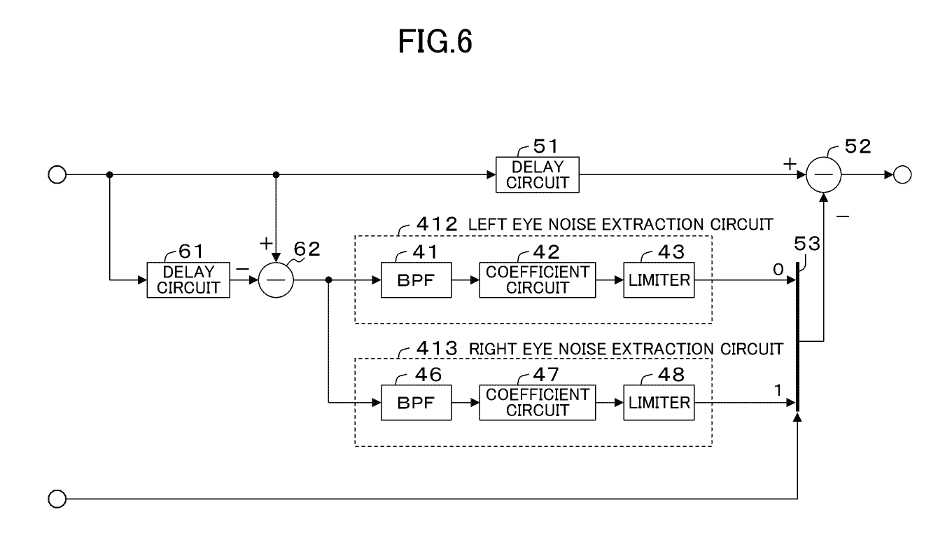

In addition to the examples of the noise reduction circuit 31 shown in FIGS. 4 and 5, a configuration as shown in FIG. 6 is also well known. In FIG. 6, a reference character 61 indicates a delay circuit, and a reference character 62 indicates a subtractor. Parts which perform the same operations as those of parts of FIGS. 4 and 5 are indicated by the same reference characters.

The delay circuit 61 is a line memory or a frame memory. By calculating the difference between the input stereoscopic video signal and the output of the delay circuit 61 using the subtractor 62, a line-to-line correlation or a frame-to-frame correlation can be obtained. For example, when the left and right eye video signals are multiplexed on a field-by-field basis as shown in FIG. 2A, the delay amount of the delay circuit 61 is one frame, and therefore, a frame-to-frame correlation between left eye video signals and a frame-to-frame correlation between right eye video signals can be determined. It is known that, in general, there is a high line-to-line or frame-to-frame correlation in video signals, but a low correlation in noise components. By utilizing this property, the delay circuit 61 and the subtractor 62 are used to extract a region having a low line-to-line or frame-to-frame correlation. The same noise reduction process as that of FIG. 5 is applied to the region, whereby the noise component can be reduced with higher accuracy.

The noise reduction circuits 31 of FIGS. 4, 5, and 6 are only for illustrative purposes. Any other circuits that can reduce noise may be used. For example, a correlation between a plurality of lines may be used, a correlation between a plurality of fields may used, or these techniques may be used in combination. Briefly, with any method that applies optimized noise reduction to the left and right eye video signals separately based on the control signal, an advantage similar to that of FIGS. 4, 5, and 6 can be achieved.

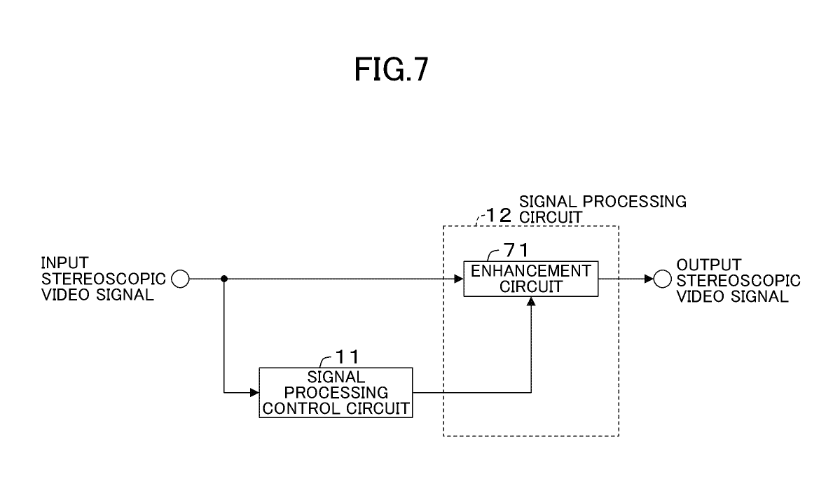

FIG. 7 shows another example of the signal processing circuit 12 in which a resolution, a detail, and a sharpness which the viewer perceives are improved. In FIG. 7, a reference character 71 indicates an enhancement circuit. The enhancement circuit 71 performs a process of enhancing a specific signal component (hereinafter referred to as an enhancement process) for the left and right eye video signals separately based on the timing of the control signal output from the signal processing control circuit 11.

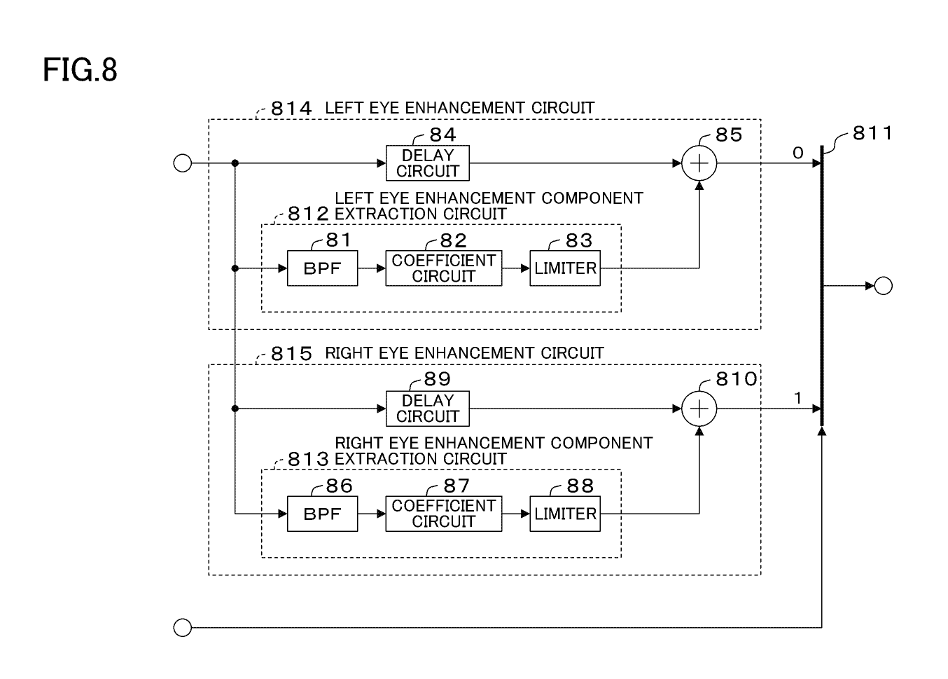

FIG. 8 shows a specific example of the enhancement circuit 71. In FIG. 8, the enhancement circuit 71 includes BPFs 81 and 86, coefficient circuits 82 and 87, limiters 83 and 88, delay circuits 84 and 89, adders 85 and 810, a selector 811, a left eye enhancement component extraction circuit 812, a right eye enhancement component extraction circuit 813, a left eye enhancement circuit (left eye enhancer) 814, and a right eye enhancement circuit (right eye enhancer) 815.

The BPF 81 passes a frequency band of the left eye video signals which is determined based on a signal component which is to be enhanced. In general video signals, a resolution or a detail which the viewer perceives is improved by enhancing a high frequency component, and a sharpness which the viewer perceives is improved by enhancing a frequency component in the vicinity of 3-4 MHz, which is visually noticeable. For example, when required to improve a resolution or a detail which the viewer perceives, the BPF 81 serves as a high-pass filter to enhance a high frequency component. When required to impart a higher sharpness to an image, the BPF 81 serves as a band-pass filter having a peak in the vicinity of 3-4 MHz. In any case, the frequency characteristics of the BPF 81 are determined based on a signal component of the left eye video signals which is to be enhanced.

The coefficient circuit 82 multiplies the output of the BPF 81 by a constant to determine an amount by which a video signal is to be enhanced (hereinafter referred to as an enhancement amount). The constant, which is typically one or less, is used to determine the percentage of the enhancement amount extracted by the BPF 81 which is considered as an actual enhancement amount. The limiter 83 sets the upper limit of the enhancement amount so as to avoid a situation in which a video signal is excessively enhanced so that a noise component is also enhanced to increase noise which the viewer perceives. By combining the coefficient circuit 82 and the limiter 83, only a necessary signal component can be advantageously enhanced.

The delay circuit 84 delays the input stereoscopic video signal by the same time as the process delay time of the left eye enhancement component extraction circuit 812, so that the adder 85 adds the extracted enhancement component to the input stereoscopic video signal with appropriate timing. In other words, the enhancement component is added to the input stereoscopic video signal, and the amount of the added enhancement component is optimized for the left eye video signals.

The BPF 86, the coefficient circuit 87, and the limiter 88 of the right eye enhancement component extraction circuit 813, the delay circuit 89, and the adder 810 perform the same operations as those of the BPF 81, the coefficient circuit 82, the limiter 83, the delay circuit 84, and the adder 85. Note that the band of the BPF 86, the constant of the coefficient circuit 87, and the upper limit of the limiter 88 are optimized for the right eye video signals, and are different from those of the left eye enhancement component extraction circuit 812.

Thus, the left eye enhancement circuit 814 adds an enhancement component optimized for the left eye to the left eye video signals, and the right eye enhancement circuit 815 adds an enhancement component optimized for the right eye to the right eye video signals. The selector 811 selects and outputs the output of the left eye enhancement circuit 814 for the left eye video signals, and the output of the right eye enhancement circuit 815 for the right eye video signals, based on the control signal from the signal processing control circuit 11. In other words, the enhancement component is added to the input stereoscopic video signal, and the enhancement amount is optimized for the left and right eye video signals separately.

As described above, the enhancement circuit 71 is provided in the signal processing circuit 12 to add, to the input stereoscopic video signal, the enhancement component optimized for the left and right eye video signals separately. Therefore, a resolution or a detail which the viewer perceives can be improved, or a sharpness which the viewer perceives can be improved. For example, if a resolution which the viewer perceives is more enhanced for one of the left and right eyes of the viewer that has worse eyesight than that of the other, resolutions perceived by the left and right eyes can be balanced, thereby improving stereoscopic perception.

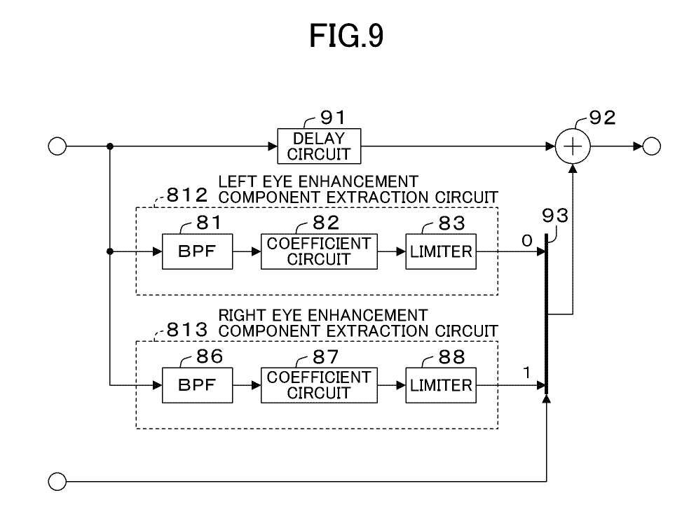

The configuration of FIG. 8 may be modified to that of FIG. 9. In FIG. 9, a reference character 91 indicates a delay circuit, a reference character 92 indicates an adder, and a reference character 93 indicates a selector. Parts which perform the same operations as those of parts of FIG. 8 are indicated by the same reference characters. In the configuration of FIG. 9, the delay circuit 91 serves as both of the delay circuits 84 and 89 of FIG. 8, and the adder 92 serves as both of the adders 85 and 810 of FIG. 8. Such a configuration has a smaller circuit size than that of FIG. 8, and therefore, the signal processing circuit 12 can be manufactured at lower cost.

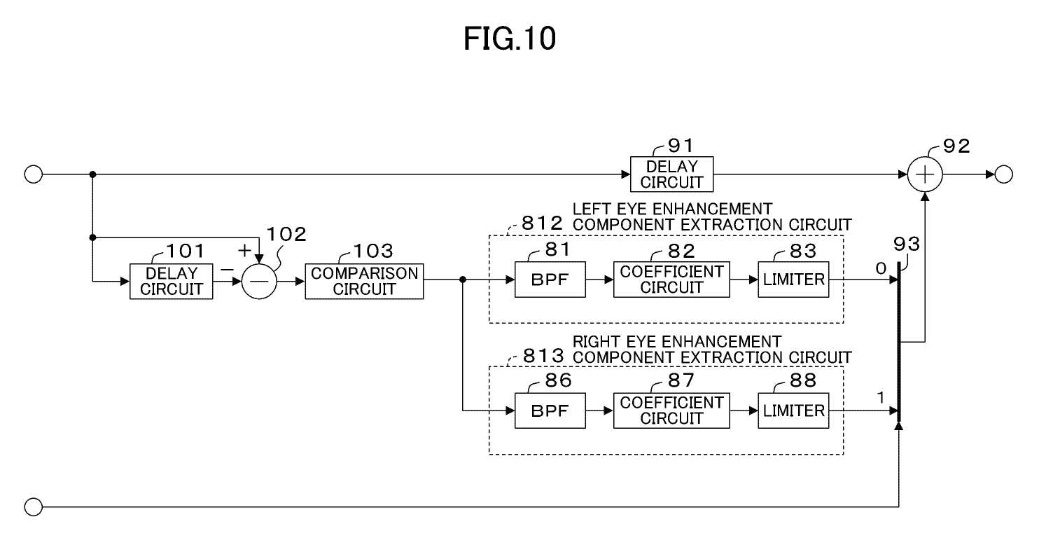

The enhancement circuits of FIGS. 8 and 9 are only for illustrative purposes. Another configuration as shown in FIG. 10 is also well known. In FIG. 10, a reference character 101 indicates a delay circuit, a reference character 102 indicates a subtractor, and a reference character 103 indicates a comparison circuit. Parts which perform the same operations as those of parts of FIGS. 8 and 9 are indicated by the same reference characters.

The delay circuit 101 is a line memory or a frame memory. By calculating the difference between the input stereoscopic video signal and the output of the delay circuit 101 using the subtractor 102, a line-to-line correlation or a frame-to-frame correlation can be obtained. For example, when the left and right eye video signals are multiplexed on a field-by-field basis as shown in FIG. 2A, the delay amount of the delay circuit 101 is one frame, and therefore, a frame-to-frame correlation between left eye video signals and a frame-to-frame correlation between right eye video signals can be obtained. It is known that, in general, there is a high line-to-line or frame-to-frame correlation in video signals, but a low correlation in noise components. By utilizing this property, the comparison circuit 103 is used to determine whether or not the output of the subtractor 102 is larger than a predetermined value, thereby extracting a region having a high line-to-line or frame-to-frame correlation. The same enhancement process as that of FIG. 9 is applied to the region, whereby the enhancement process can be performed with higher accuracy without enhancing a noise component.

The enhancement circuits 71 of FIGS. 8, 9, and 10 are only for illustrative purposes. Any other circuits that can perform the enhancement process may be used. For example, a correlation between a plurality of lines may be used, a correlation between a plurality of fields may used, or these techniques may be used in combination. Briefly, with any method that applies optimized noise reduction to the left and right eye video signals separately based on the control signal, an advantage similar to that of FIGS. 8, 9, and 10 can be achieved.

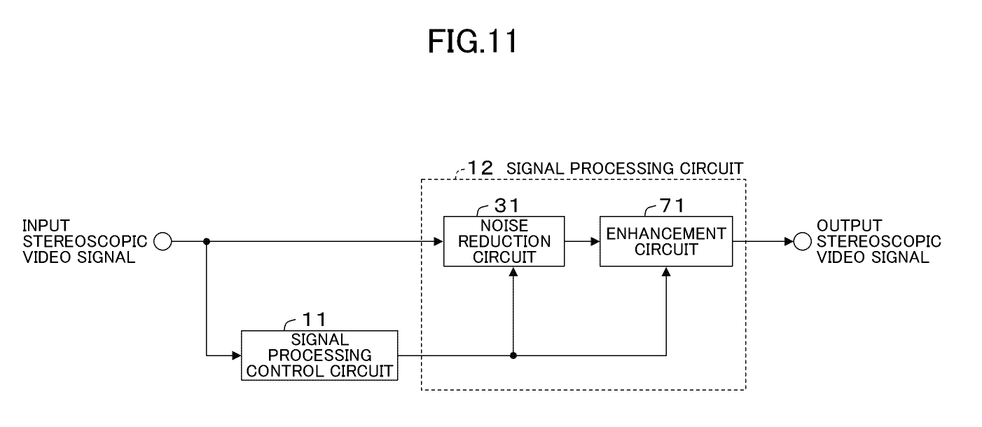

Note that the signal processing circuit 12 only needs to apply different processes to the left and right eye video signals. The present disclosure is, of course, not limited to the noise reduction circuit 31 or the enhancement circuit 71 described above. For example, as shown in FIG. 11, the noise reduction circuit 31 and the enhancement circuit 71 may be used in combination. For example, the process may be a process of converting an interlaced image into a progressive image (hereinafter referred to as IP conversion). Alternatively, for example, the process may be a process of enlarging or reducing an image.

As described above, according to this embodiment, different processes can be applied to the left and right eye video signals, whereby signal processing can be optimized. As a result, noise can be reduced, and a resolution, a detail, and a sharpness which the viewer perceives can be improved, etc., and in addition, stereoscopic perception can be improved.

Although the stereoscopic glasses 203 include liquid crystal shutters in the above description, the stereoscopic glasses 203 may include polarizing lenses instead of the liquid crystal shutters, and the display 201 may change polarization of emitted light, depending on the left and right eye video signals, thereby providing stereoscopic viewing. Alternatively, instead of using the stereoscopic glasses 203, a surface of the display 201 may be covered with a lenticular lens, thereby providing stereoscopic viewing with naked eyes. In any case, it is clearly understood that the present disclosure is directly applicable to any display scheme of the stereoscopic display device 205 that provides stereoscopic viewing using the left and right eye video signals.

### Second Embodiment

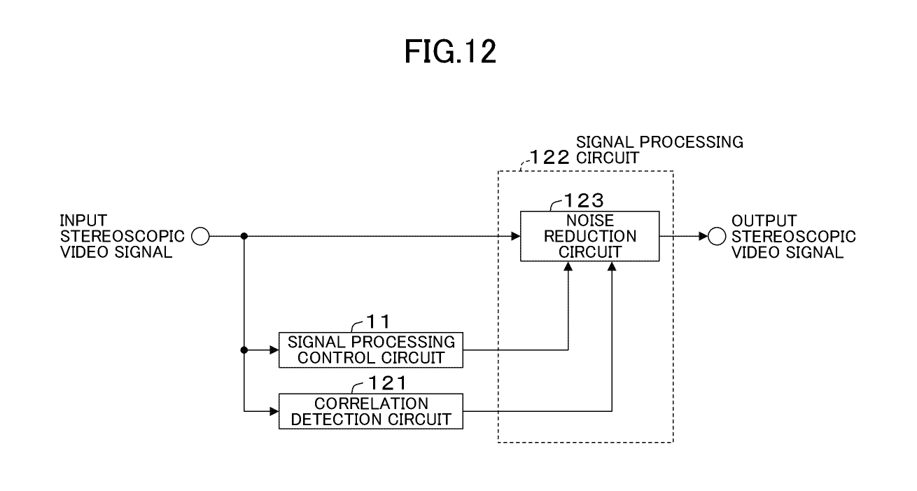

FIG. 12 is a block diagram showing a configuration of a signal processing device according to a second embodiment of the present disclosure. The signal processing device of FIG. 12 includes a signal processing control circuit 11, a correlation detection circuit 121, and a signal processing circuit 122. Note that stereoscopic viewing can be provided by connecting the stereoscopic display device 205 described in the above BACKGROUND section to a stage succeeding the signal processing device of FIG. 12. The stereoscopic display device 205 described in the above BACKGROUND section will not be described in detail.

In the configuration of FIG. 12, the signal processing control circuit (signal processing controller) 11 generates a signal indicating timings at which signal processing is applied to left eye video signals, and a signal indicating timings at which signal processing is applied to right eye video signals, to control the signal processing circuit 12. The correlation detection circuit (correlation detector) 121 detects a correlation between a left eye video signal and a right eye video signal, and outputs the result of the detection. Based on the timing signals output by the signal processing control circuit 11 and the detection results output by the correlation detection circuit 121, the signal processing circuit (signal processor) 122 processes the left and right eye video signals separately.

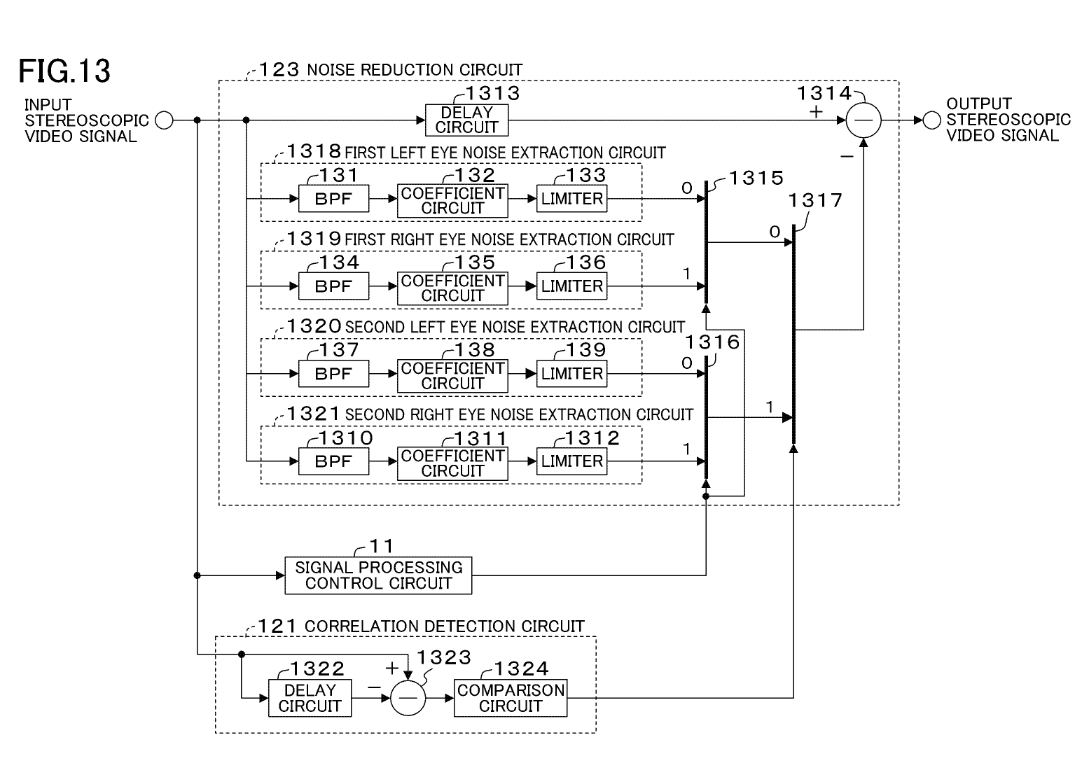

An example of the signal processing circuit 122 is a noise reduction circuit 123. FIG. 13 shows specific example configurations of the noise reduction circuit 123 and the correlation detection circuit 121. The noise reduction circuit 123 includes BPFs 131, 134, 137, and 1310, coefficient circuits 132, 135, 138, and 1311, limiters 133, 136, 139, and 1312, a delay circuit 1313, a subtractor 1314, selectors 1315, 1316, and 1317, a first left eye noise extraction circuit 1318, a first right eye noise extraction circuit 1319, a second left eye noise extraction circuit 1320, and a second right eye noise extraction circuit 1321. The correlation detection circuit 121 includes a delay circuit 1322, a subtractor 1323, and a comparison circuit 1324.

The first left eye noise extraction circuit 1318 including the BPF 131, the coefficient circuit 132, and the limiter 133, the first right eye noise extraction circuit 1319 including the BPF 134, the coefficient circuit 135, and the limiter 136, the second left eye noise extraction circuit 1320 including the BPF 137, the coefficient circuit 138, and the limiter 139, and the second right eye noise extraction circuit 1321 including the BPF 1310, the coefficient circuit 1311, and the limiter 1312, perform operations similar to those of the left and right eye noise extraction circuits 412 and 413 of FIG. 4, and therefore, will not be described in detail. In FIG. 13, in the noise reduction circuit 123, the first and second left and right eye noise detection circuits 1318-1321 share the delay circuit 1313, the subtractor 1314, and the three selectors 1315, 1316, and 1317, thereby forming first and second left and right eye noise reduction circuits.

The correlation detection circuit 121 detects a correlation between a left eye video signal and a right eye video signal. If it is assumed that the left and right eye video signals are multiplexed on a field-by-field basis as shown in FIG. 2A, the delay circuit 1322 delays the input stereoscopic video signal by a period of time corresponding to one field+a binocular parallax. The difference between the delayed input stereoscopic video signal and the original input stereoscopic video signal is calculated by the subtractor 1323. The output of the subtractor 1323 is close to zero (0) in a region where there is a high correlation between a left eye video signal and a right eye video signal, i.e., a region where images viewed by the left and right eyes are similar to each other (i.e., there is substantially no binocular parallax). Conversely, the output of the subtractor 1323 is large in a region where there is a low correlation, i.e., a region where images viewed by the left and right eyes are different from each other (i.e., there is a binocular parallax). Therefore, the comparison circuit 1324 compares the output of the subtractor 1323 with a predetermined threshold to output zero (0) in a region having a high correlation and one (1) in a region having a low correlation.

The selector 1317 is controlled based on the output of the correlation detection circuit 121 to select the output of the first left eye noise extraction circuit 1318 or the output of the first right eye noise extraction circuit 1319 in a region having a high correlation. The selectors 1315 and 1316 are switched based on the output of the signal processing control circuit 11. Therefore, the output of the first left eye noise extraction circuit 1318 is selected in a region where there is a high correlation between the light and right eyes of a left eye video signal, and the output of the first right eye noise extraction circuit 1319 is selected in a region where there is a high correlation between the light and right eyes of a right eye video signal, and the selected outputs are supplied to the subtractor 1314. Similarly, the output of the second left eye noise extraction circuit 1320 is selected in a region where there is a low correlation between the light and right eyes of a left eye video signal, and the output of the second right eye noise extraction circuit 1321 is selected in a region where there is a low correlation between the light and right eyes of a right eye video signal, and the selected outputs are supplied to the subtractor 1314.

After the timing of the input stereoscopic video signal is adjusted by the delay circuit 1313, the extracted noise is subtracted from the input stereoscopic video signal by the subtractor 1314, and the noise-reduced stereoscopic video signal is output. Therefore, in a region where the correlation detection circuit 121 has detected a high correlation, a first left eye noise reduction process which is performed by the noise extraction circuit 1318 is applied to a left eye video signal, and a first right eye noise reduction process which is performed by the first right eye noise extraction circuit 1319 is applied to a right eye video signal. In a region where the correlation detection circuit 121 has detected a low correlation, a second left eye noise reduction process which is performed by the second left eye noise extraction circuit 1320 is applied to a left eye video signal, and a second right eye noise reduction process which is performed by the second right eye noise extraction circuit 1321 is applied to a right eye video signal.

The BPF 131 may be the same as the BPF 134, the coefficient circuit 132 may be the same as the coefficient circuit 135, and the limiter 133 may be the same as the limiter 136. In this case, in a region where there is a high correlation between a left eye video signal and a right eye video signal, noise is substantially equally reduced in the left and right eye video signals, and therefore, a noise reduction effect similar to that which is obtained when the noise reduction process is applied to a normal video signal, which is not a stereoscopic signal, is obtained. On the other hand, in a region having a low correlation, optimized noise reduction processes are applied to the left and right eye video signals separately, whereby it is possible to reduce a mismatch between the left and right eye video signals, and therefore, stereoscopic perception is not impaired.

Of course, the BPFs 131 and 134 may have different characteristics, the coefficient circuits 132 and 135 may have different characteristics, and the limiters 133 and 136 may have different characteristics. In this case, for example, if noise is more reduced for one of the left and right eyes of the viewer that has better eyesight than that of the other, noise perceived by the left and right eyes can be balanced, thereby improving stereoscopic perception.

Note that, in FIG. 13, the selector 1317 controlled by the correlation detection circuit 121 is provided at a stage succeeding the selectors 1315 and 1316 controlled by the signal processing control circuit 11. Even if this sequence is reversed, the same effect is obtained. Specifically, the first left eye noise reduction process is applied to a region where the correlation detection circuit 121 has detected a high correlation, and the second left eye noise reduction process is applied to a region where the correlation detection circuit 121 has not detected a high correlation. Similarly, the first right eye noise reduction process is applied to a region where the correlation detection circuit 121 has detected a high correlation, and the second right eye noise reduction process is applied to a region where the correlation detection circuit 121 has not detected a high correlation. By selecting one of the resultant left and right eye video signals using the control signal output by the signal processing control circuit 11, an advantage similar to that of FIG. 13 is obtained. In other words, by providing the left and right eye noise reduction processes which are controlled by the correlation detection circuit 121, and selecting one of the resultant left and right eye video signals using the control signal output by the signal processing control circuit 11, an advantage similar to that of FIG. 13 is obtained.

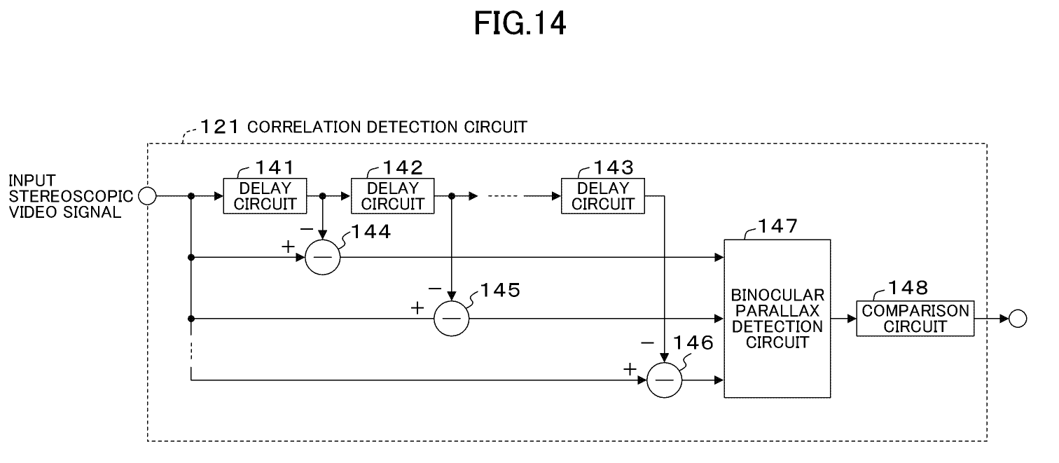

If a binocular parallax between the left and right eyes can be uniquely determined, the delay circuit 1322 of FIG. 13 can be used to form the correlation detection circuit 121. If, however, the binocular parallax varies depending on the input stereoscopic video signal, the binocular parallax needs to be detected. FIG. 14 shows a specific example configuration in such a case of the correlation detection circuit 121. The correlation detection circuit 121 includes delay circuits 141, 142, and 143, subtractors 144, 145, and 146, a binocular parallax detection circuit 147, and a comparison circuit 148.

The delay amount of the delay circuit 141 varies depending on the scheme of multiplexing the left and right eye video signals. When the left and right eye video signals are multiplexed on a field-by-field basis as shown in FIG. 2A, the delay amount is, for example, one field. When the left and right eye video signals are multiplexed on a line-by-line basis as shown in FIG. 2B, the delay amount is, for example, one line. In contrast to this, the delay amounts of the delay circuits 142 and 143 are one pixel. The delay circuits 141, 142, and 143 and the subtractors 144, 145, and 146 can be used to delay one of a left eye video signal and a right eye video signal from the other on a pixel-by-pixel basis, and calculate the difference between the left and right eye video signals. If the number of the delay circuits 142 and 143 is sufficient to cover the binocular parallax, the output of one of the subtractors 144, 145, and 146 is minimum at a portion where there is a maximum correlation. If the minimum subtractor output is detected by the detection circuit 147, a delay amount corresponding to the binocular parallax is obtained. Such detection may be performed once during initialization, or may be performed on a field-by-field basis. As a result of the detection by the binocular parallax detection circuit 147, a subtractor is selected which outputs the difference between the original input stereoscopic video signal and the input stereoscopic video signal delayed by the delay amount corresponding to the binocular parallax, and the comparison circuit 148 compares the output of such a subtractor with a threshold to output the magnitude of the correlation.

As described above, by providing the correlation detection circuit 121, optimized noise reduction processes can be applied to the left and right eye video signals separately, and therefore, a mismatch does not occur between the left and right eye video signals, whereby noise can be reduced without impairing stereoscopic perception.

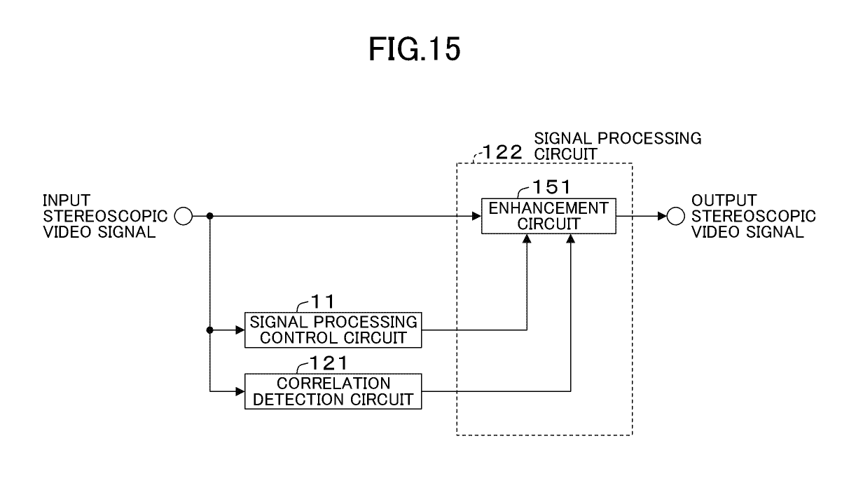

FIG. 15 shows an example in which an enhancement circuit 151 is used as the signal processing circuit 122. The signal processing control circuit 11 and the correlation detection circuit 121 perform the same operations as those which have been described in FIG. 13, and therefore, will not be described in detail. The enhancement circuit 151 is controlled by the signal processing control circuit 11 and the correlation detection circuit 121 so that the enhancement circuit 151 applies optimized enhancement processes to input left and right eye video signals separately.

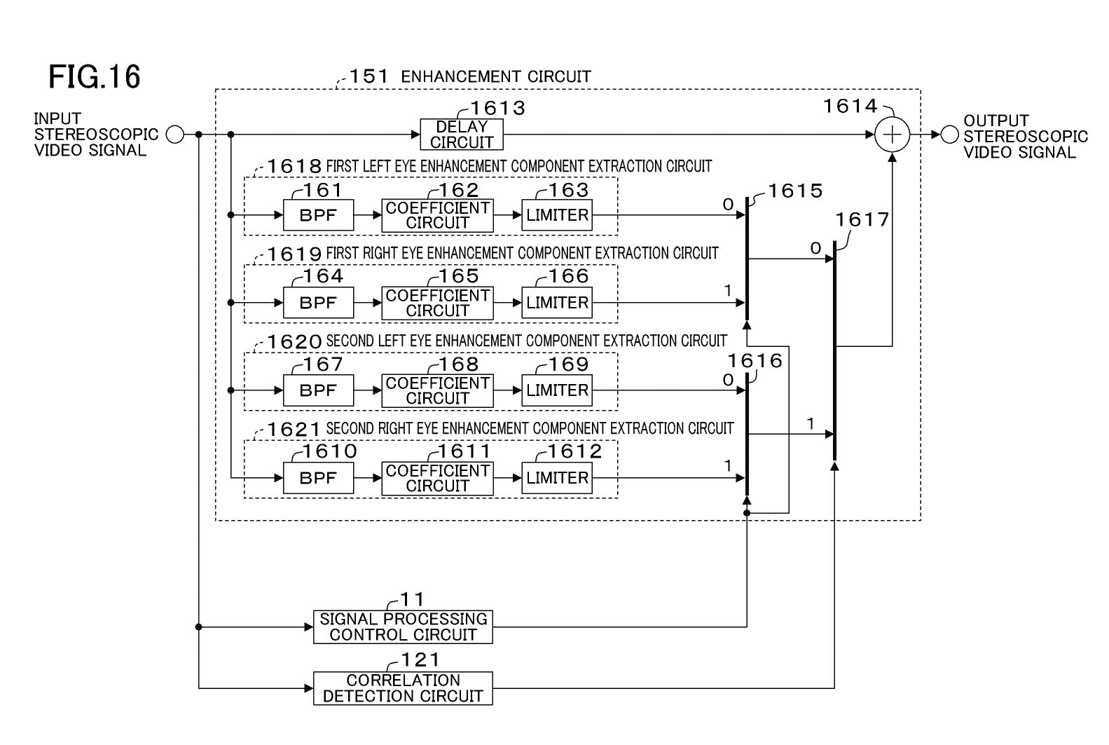

FIG. 16 shows a specific example configuration of the enhancement circuit 151. The enhancement circuit 151 includes BPFs 161, 164, 167, and 1610, coefficient circuits 162, 165, 168, and 1611, limiters 163, 166, 169, and 1612, a delay circuit 1613, an adder 1614, selectors 1615, 1616, and 1617, a first left eye enhancement component extraction circuit 1618, a first right eye enhancement component extraction circuit 1619, a second left eye enhancement component extraction circuit 1620, and a second right eye enhancement component circuit 1621.

The first left eye enhancement component extraction circuit 1618 including the BPF 161, the coefficient circuit 162, and the limiter 163, the first right eye enhancement component extraction circuit 1619 including the BPF 164, the coefficient circuit 165, and the limiter 166, the second left eye enhancement component extraction circuit 1620 including the BPF 167, the coefficient circuit 168, and the limiter 169, and the second right eye enhancement component extraction circuit 1621 including the BPF 1610, the coefficient circuit 1611, and the limiter 1612, perform operations similar to those of the left and right eye enhancement component extraction circuits 812 and 813 of FIG. 8, and therefore, will not be described in detail. In FIG. 16, in the enhancement circuit 151, the first and second left and right eye enhancement component extraction circuits 1618-1621 share the delay circuit 1613, the adder 1614, and the three selectors 1615, 1616, and 1617, and serve as first and second left and right eye enhancers, respectively.

The selector 1617 is controlled based on the output of the correlation detection circuit 121 to select the output of the first left eye enhancement component extraction circuit 1618 or the output of the first right eye enhancement component extraction circuit 1619 in a region having a high correlation. The selectors 1615 and 1616 are switched based on the output of the signal processing control circuit 11. Therefore, the output of the first left eye enhancement component extraction circuit 1618 is selected in a region where there is a high correlation between the left and right eyes of a left eye video signal, and the output of the first right eye enhancement component extraction circuit 1619 is selected in a region where there is a high correlation between the left and right eyes of a right eye video signal, and the selected outputs are supplied to the adder 1614. Similarly, the output of the second left eye enhancement component extraction circuit 1620 is selected in a region where there is a low correlation between the left and right eyes of a left eye video signal, and the output of the second right eye enhancement component extraction circuit 1621 is selected in a region where there is a low correlation between the left and right eyes of a right eye video signal, and the selected outputs are supplied to the adder 1614.

After the timing of the input stereoscopic video signal is adjusted by the delay circuit 1613, the extracted enhancement component is added to the input stereoscopic video signal by the adder 1614 to output the stereoscopic video signal in which a predetermined signal component is enhanced. Therefore, in a region where the correlation detection circuit 121 has detected a high correlation, a first left eye enhancement process which is performed by the first left eye enhancement component extraction circuit 1618 is applied to the left eye video signal, and a first right eye enhancement process which is performed by the first right eye enhancement component extraction circuit 1619 is applied to the right eye video signal. In a region where the correlation detection circuit 121 has detected a low correlation, a second left eye enhancement process which is performed by the second left eye enhancement component extraction circuit 1620 is applied to the left eye video signal, and a second right eye enhancement process which is performed by the second right eye enhancement component extraction circuit 1621 is applied to the right eye video signal.

The BPF 161 may be the same as the BPF 164, the coefficient circuit 162 may be the same as the coefficient circuit 165, and the limiter 163 may be the same as the limiter 166. In this case, in a region where there is a high correlation between a left eye video signal and a right eye video signal, the signal component is substantially equally enhanced in the left and right eye video signals, and therefore, a resolution perception improving effect similar to that which is obtained when the enhancement process is applied to a normal video signal, which is not a stereoscopic signal, is obtained. On the other hand, in a region having a low correlation, optimized enhancement processes are applied to the left and right eye video signals separately, whereby it is possible to reduce or prevent a mismatch between the left and right eye video signals, and therefore, stereoscopic perception is not impaired.

Of course, the BPFs 161 and 164 may have different characteristics, the coefficient circuits 162 and 165 may have different characteristics, and the limiters 163 and 166 may have different characteristics. In this case, for example, if the signal component is more enhanced for one of the left and right eyes of the viewer that has worse eyesight than that of the other, resolutions perceived by the left and right eyes can be balanced, thereby improving stereoscopic perception.

Note that, in FIG. 16, the selector 1617 controlled by the correlation detection circuit 121 is provided at a stage succeeding the selectors 1615 and 1616 controlled by the signal processing control circuit 11. Even if this sequence is reversed, the same effect is obtained. Specifically, the first left eye enhancement process is applied to a region where the correlation detection circuit 121 has detected a high correlation, and the second left eye enhancement process is applied to a region where the correlation detection circuit 121 has not detected a high correlation. Similarly, the first right eye enhancement process is applied to a region where the correlation detection circuit 121 has detected a high correlation, and the second right eye enhancement process is applied to a region where the correlation detection circuit 121 has not detected a high correlation. By selecting one of the resultant left and right eye video signals using the control signal output by the signal processing control circuit 11, an advantage similar to that of FIG. 16 is obtained. In other words, by providing the left and right eye enhancement processes which are controlled by the correlation detection circuit 121, and selecting one of the resultant left and right eye video signals using the control signal output by the signal processing control circuit 11, an advantage similar to that of FIG. 16 is obtained.

As described above, by providing the correlation detection circuit 121, optimized enhancement processes can be applied to the left and right eye video signals separately, and therefore, a mismatch does not occur between the left and right eye video signals, whereby noise can be reduced without impairing stereoscopic perception.

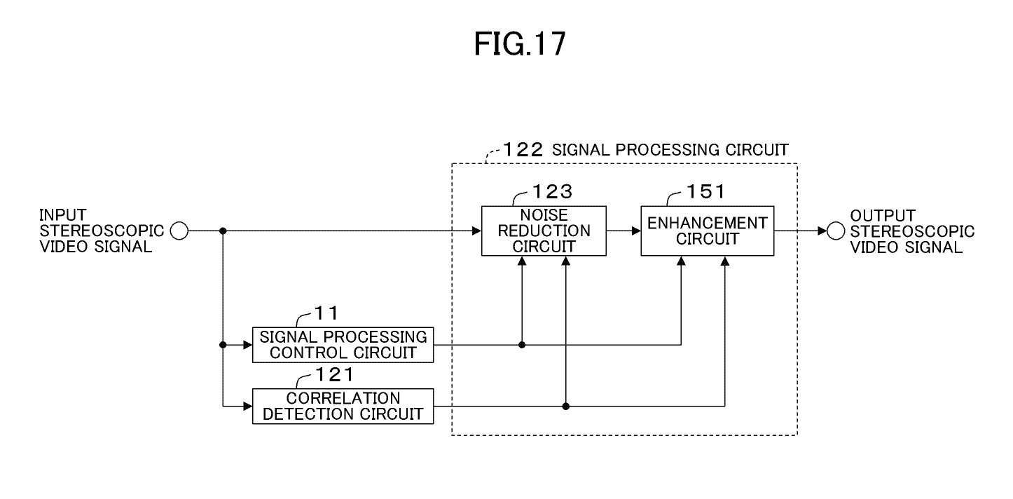

Note that the signal processing circuit 122 only needs to apply different processes to the left and right eye video signals. The present disclosure is, of course, not limited to the noise reduction circuit 123 or the enhancement circuit 151 described above. For example, as shown in FIG. 17, the noise reduction circuit 123 and the enhancement circuit 151 may be used in combination. For example, the process may be a process of converting an interlaced image into a progressive image (hereinafter referred to as IP conversion). Alternatively, for example, the process may be a process of enlarging or reducing an image.

As described above, according to this embodiment, different processes can be applied to the left and right eye video signals, whereby signal processing can be optimized. As a result, noise can be reduced, and a resolution, a detail, and a sharpness which the viewer perceives can be improved, etc., and in addition, stereoscopic perception can be improved.

Although the stereoscopic glasses 203 include liquid crystal shutters in the above description, the stereoscopic glasses 203 may include polarizing lenses instead of the liquid crystal shutters, and the display 201 may change polarization of emitted light, depending on the left and right eye video signals, thereby providing stereoscopic viewing. Alternatively, instead of using the stereoscopic glasses 203, a surface of the display 201 may be covered with a lenticular lens, thereby providing stereoscopic viewing with naked eyes. In any case, it is clearly understood that the present disclosure is directly applicable to any display scheme of the stereoscopic display device 205 that provides stereoscopic viewing using the left and right eye video signals.

### Third Embodiment

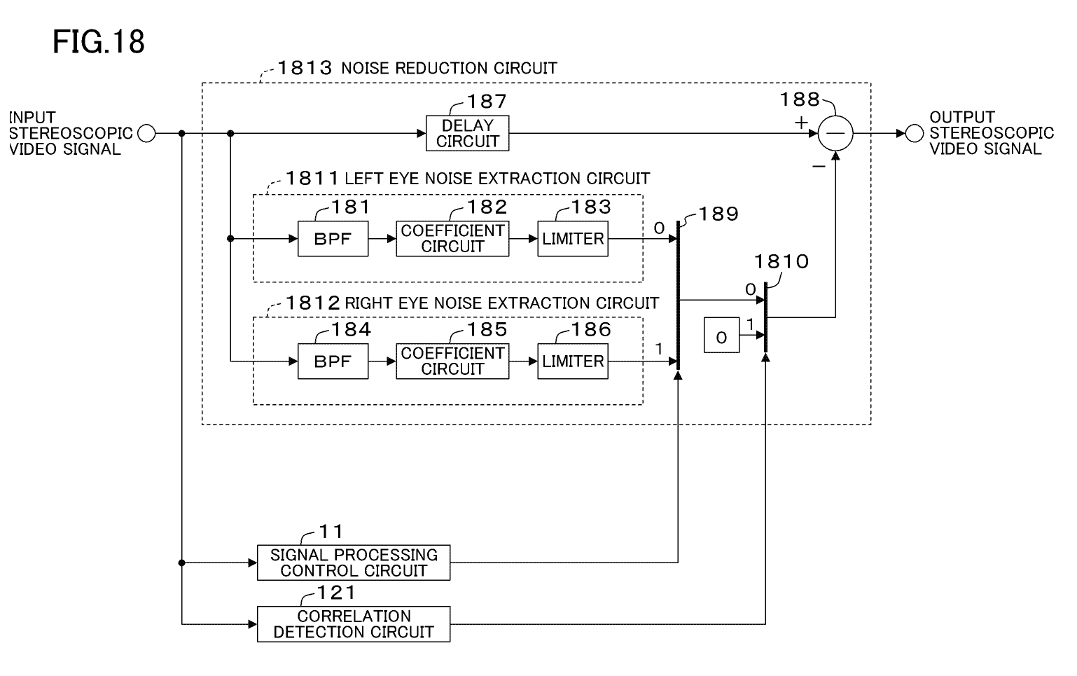

FIG. 18 is a block diagram showing a configuration of a signal processing device according to a third embodiment of the present disclosure. The signal processing device of FIG. 18 includes a signal processing control circuit 11, a correlation detection circuit (correlation detector) 121, and a noise reduction circuit 1813 which is an example signal processing circuit (signal processor). Note that stereoscopic viewing can be provided by connecting the stereoscopic display device 205 described in the above BACKGROUND section to a stage succeeding the signal processing device of FIG. 18. The stereoscopic display device 205 described in the above BACKGROUND section will not be described in detail.

The noise reduction circuit 1813 include BPFs 181 and 184, coefficient circuits 182 and 185, limiters 183 and 186, a delay circuit 187, a subtractor 188, selectors 189 and 1810, a left eye noise extraction circuit 1811, and a right eye noise extraction circuit 1812. The signal processing control circuit 11 and the correlation detection circuit 121 perform the same operations as those of FIG. 12, and therefore, will not be described in detail. The left eye noise extraction circuit 1811 and the right eye noise extraction circuit 1812 also perform operations similar to those of the left eye noise extraction circuit 412 and the right eye noise extraction circuit 413 of FIG. 4, and therefore, will not be described in detail. In FIG. 18, the left eye noise extraction circuit 1811, the delay circuit 187, the subtractor 188, and the two selectors 189 and 1810 constitute a left eye noise reducer, and the right eye noise extraction circuit 1812, the delay circuit 187, the subtractor 188, and the two selectors 189 and 1810 constitute a right eye noise reducer.

In the configuration of FIG. 18, the signal processing control circuit 11 generates a signal indicating timings at which signal processing is applied to left eye video signals, and a signal indicating timings at which signal processing is applied to right eye video signals, to control the noise reduction circuit 1813. The correlation detection circuit 121 detects a correlation between a left eye video signal and a right eye video signal, and outputs the result of the detection. Based on the timing signals output by the signal processing control circuit 11 and the detection results output by the correlation detection circuit 121, the noise reduction circuit 1813 processes the left and right eye video signals separately.

The selector 1810 is controlled based on the output of the correlation detection circuit 121 to select the output of the left eye noise extraction circuit 1811 or the output of the right eye noise extraction circuit 1812 in a region having a high correlation. The selector 189 is switched based on the output of the signal processing control circuit 11. Therefore, the output of the left eye noise extraction circuit 1811 is selected in a region where there is a high correlation between the light and right eyes of a left eye video signal, and the output of the right eye noise extraction circuit 1812 is selected in a region where there is a high correlation between the light and right eyes of a right eye video signal, and the selected outputs are supplied to the subtractor 188. On the other hand, the value zero (0) is selected in a region where there is a low correlation between the light and right eyes, and the selected value is supplied to the subtractor 188.

After the timing of the input stereoscopic video signal is adjusted by the delay circuit 187, the extracted noise is subtracted from the input stereoscopic video signal by the subtractor 188, and the noise-reduced stereoscopic video signal is output. Therefore, in a region where the correlation detection circuit 121 has detected a high correlation, a left eye noise reduction process which is performed by the noise extraction circuit 1811 is applied to a left eye video signal, and a right eye noise reduction process which is performed by the right eye noise extraction circuit 1812 is applied to a right eye video signal. In a region where the correlation detection circuit 121 has detected a low correlation, the value zero (0) is selected by the selector 1810, and therefore, no noise reduction process is performed.

The BPF 181 may be the same as the BPF 184, the coefficient circuit 182 may be the same as the coefficient circuit 185, and the limiter 183 may be the same as the limiter 186. In this case, in a region where there is a high correlation between a left eye video signal and a right eye video signal, noise is substantially equally reduced in the left and right eye video signals, and therefore, a noise reduction effect similar to that which is obtained when the noise reduction process is applied to a normal video signal, which is not a stereoscopic signal, is obtained. On the other hand, in a region having a low correlation, no noise reduction process is applied to the left and right eye video signals, so that a mismatch does not occur between the left and right eye video signals, and therefore, stereoscopic perception is not impaired.

Of course, the BPFs 181 and 184 may have different characteristics, the coefficient circuits 182 and 185 may have different characteristics, and the limiters 183 and 186 may have different characteristics. In this case, for example, if noise is more reduced for one of the left and right eyes of the viewer that has better eyesight than that of the other, noise perceived by the left and right eyes can be balanced, thereby improving stereoscopic perception.

Note that, in FIG. 18, the selector 1810 controlled by the correlation detection circuit 121 is provided at a stage succeeding the selector 189 controlled by the signal processing control circuit 11. Even if this sequence is reversed, the same effect is obtained. Specifically, the left eye noise extraction process is applied to a region where the correlation detection circuit 121 has detected a high correlation, and no process is applied to a region where the correlation detection circuit 121 has not detected a high correlation. Similarly, the right eye noise extraction process is applied to the region where the correlation detection circuit 121 has detected a high correlation, and no process is applied to the region where the correlation detection circuit 121 has not detected a high correlation. By selecting one of the resultant left and right eye video signals using the control signal output by the signal processing control circuit 11, an advantage similar to that of FIG. 18 is obtained.

As described above, by providing the correlation detection circuit 121, optimized enhancement processes can be applied to the left and right eye video signals separately, and therefore, a mismatch does not occur between the left and right eye video signals, whereby noise can be reduced without impairing stereoscopic perception.

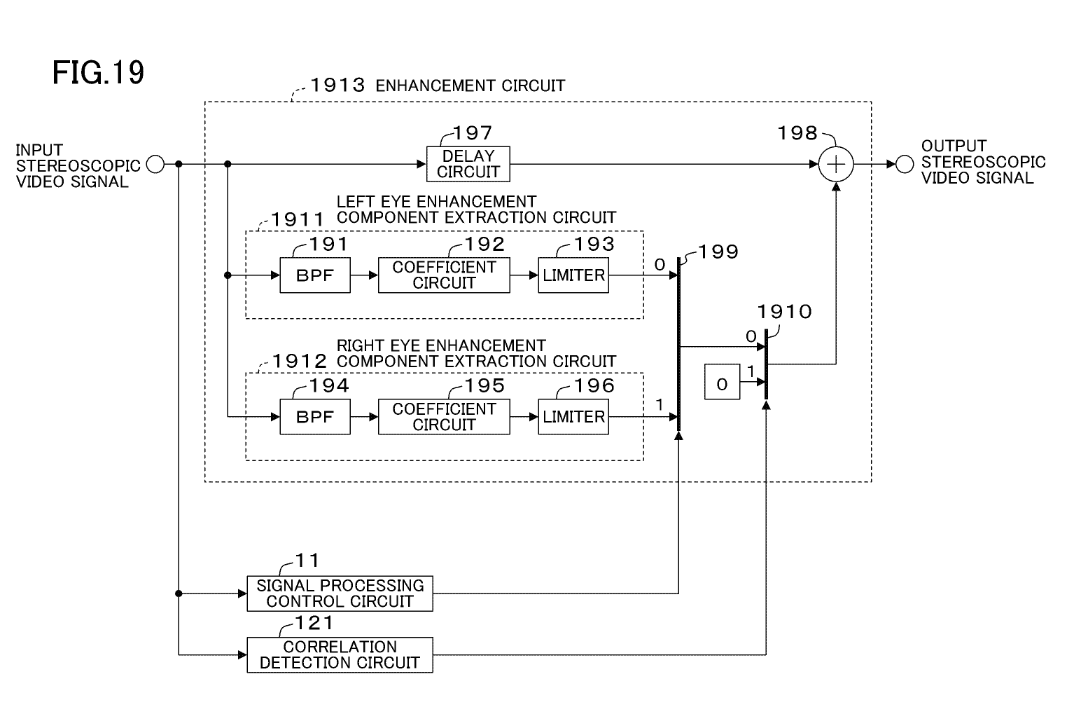

A signal processing device of FIG. 19 includes a signal processing control circuit 11, a correlation detection circuit 121, and an enhancement circuit 1913 which is an example signal processing circuit. The enhancement circuit 1913 includes BPFs 191 and 194, coefficient circuits 192 and 195, limiters 193 and 196, a delay circuit 197, an adder 198, selectors 199 and 1910, a left eye enhancement component extraction circuit 1911, and a right eye enhancement component extraction circuit 1912. The signal processing circuit 11 and the correlation detection circuit 121 perform the same operations as those of FIG. 12, and therefore, will not be described in detail. The left and right eye enhancement component extraction circuits 1911 and 1912 perform operations similar to those of the left and right eye enhancement component extraction circuits 812 and 813 of FIG. 8, and therefore, will not be described in detail. In FIG. 19, the left eye enhancement component extraction circuit 1911, the delay circuit 197, the subtractor 198, and the two selectors 199 and 1910 constitute a left eye enhancer, and the right eye enhancement component extraction circuit 1912, the delay circuit 197, the subtractor 198, and the two selectors 199 and 1910 constitute a right eye enhancer.

The selector 1910 is controlled based on the output of the correlation detection circuit 121 to select the output of the left eye enhancement component extraction circuit 1911 or the output of the right eye enhancement component extraction circuit 1912 in a region having a high correlation. The selector 199 is switched based on the output of the signal processing control circuit 11. Therefore, the output of the left eye enhancement component extraction circuit 1911 is selected in a region where there is a high correlation between the light and right eyes of a left eye video signal, and the output of the right eye enhancement component extraction circuit 1912 is selected in a region where there is a high correlation between the light and right eyes of a right eye video signal, and the selected outputs are supplied to the adder 198. On the other hand, the value zero (0) is selected in a region where there is a low correlation between the light and right eyes, and the selected value is supplied to the adder 198.

After the timing of the input stereoscopic video signal is adjusted by the delay circuit 197, the extracted enhancement component is added to the input stereoscopic video signal by the adder 198 to output the stereoscopic video signal in which a predetermined signal component is enhanced. Therefore, in a region where the correlation detection circuit 121 has detected a high correlation, a left eye enhancement process which is performed by the left enhancement component extraction circuit 1911 is applied to the left eye video signal, and a right eye enhancement process which is performed by the right eye enhancement component extraction circuit 1912 is applied to the right eye video signal. In a region where the correlation detection circuit 121 has detected a low correlation, the value zero (0) is selected by the selector 1910, and therefore, no enhancement process is performed.

The BPF 191 may be the same as the BPF 194, the coefficient circuit 192 may be the same as the coefficient circuit 195, and the limiter 193 may be the same as the limiter 196. In this case, in a region where there is a high correlation between a left eye video signal and a right eye video signal, the signal component is substantially equally enhanced in the left and right eye video signals, and therefore, the effect of improving a resolution, a detail, and a sharpness which the viewer perceives, that is similar to that which is obtained when the enhancement process is applied to a normal video signal, which is not a stereoscopic signal, is obtained. On the other hand, in a region having a low correlation, no enhancement process is applied to the left and right eye video signals, so that a mismatch does not occur between the left and right eye video signals, and therefore, stereoscopic perception is not impaired.

Of course, the BPFs 191 and 194 may have different characteristics, the coefficient circuits 192 and 195 may have different characteristics, and the limiters 193 and 196 may have different characteristics. In this case, for example, if the signal component is more enhanced for one of the left and right eyes of the viewer that has worse eyesight than that of the other, resolutions perceived by the left and right eyes can be balanced, thereby improving stereoscopic perception.

Note that, in FIG. 19, the selector 1910 controlled by the correlation detection circuit 121 is provided at a stage succeeding the selector 199 controlled by the signal processing control circuit 11. Even if this sequence is reversed, the same effect is obtained. Specifically, the left eye enhancement component extraction process is applied to a region where the correlation detection circuit 121 has detected a high correlation, and no process is applied to a region where the correlation detection circuit 121 has not detected a high correlation. Similarly, the right eye enhancement component extraction process is applied to a region where the correlation detection circuit 121 has detected a high correlation, and no process is applied to a region where the correlation detection circuit 121 has not detected a high correlation. By selecting one of the resultant left and right eye video signals using the control signal output by the signal processing control circuit 11, an advantage similar to that of FIG. 19 is obtained.

Note that the signal processing circuit 122 only needs to apply different processes to the left and right eye video signals. The present disclosure is, of course, not limited to the noise reduction circuit 123 or the enhancement circuit 151 described above. For example, the noise reduction circuit 123 and the enhancement circuit 151 may be used in combination.

As described above, by providing the correlation detection circuit 121, optimized enhancement processes can be applied to the left and right eye video signals separately, and therefore, a mismatch does not occur between the left and right eye video signals, whereby a resolution, a detail, and a sharpness which the viewer perceives can be reduced without impairing stereoscopic perception.

Although the stereoscopic glasses 203 include liquid crystal shutters in the above description, the stereoscopic glasses 203 may include polarizing lenses instead of the liquid crystal shutters, and the display 201 may change polarization of emitted light, depending on left and right eye video signals, thereby providing stereoscopic viewing. Alternatively, instead of using the stereoscopic glasses 203, a surface of the display 201 may be covered with a lenticular lens, thereby providing stereoscopic viewing with naked eyes. In any case, it is clearly understood that the present disclosure is directly applicable to any display scheme of the stereoscopic display device 205 that provides stereoscopic viewing using the left and right eye video signals.

As described above, according to the present disclosure, when a stereoscopic video signal is displayed, a mismatch between a left eye image and a right eye image is reduced or prevented, whereby an impairment of stereoscopic perception is reduced or prevented. Therefore, the present disclosure can improve image quality when stereoscopic video is displayed.

1. A signal processing device for processing a stereoscopic video signal including a left eye video signal and a right eye video signal, comprising:
a signal processing controller configured to output a control signal including a timing at which the left eye video signal of the stereoscopic video signal is processed and a timing at which the right eye video signal of the stereoscopic video signal is processed; and
a signal processor configured to apply different signal processes to the left and right eye video signals based on the control signal of the signal processing controller.

2. The signal processing device of claim 1, wherein the signal processor includes
a left eye noise reducer configured to reduce a noise component of the left eye video signal, and
a right eye noise reducer configured to reduce a noise component of the right eye video signal.

3. The signal processing device of claim 1, wherein the signal processor includes
a left eye enhancer configured to enhance a predetermined signal component of the left eye video signal, and
a right eye enhancer configured to enhance a predetermined signal component of the right eye video signal.

4. A signal processing device for processing a stereoscopic video signal including a left eye video signal and a right eye video signal, comprising:
a signal processing controller configured to output a control signal including a timing at which the left eye video signal of the stereoscopic video signal is processed and a timing at which the right eye video signal of the stereoscopic video signal are processed:
a correlation detector configured to detect a correlation between the left and right eye video signals and output a result of the detection; and
a signal processor configured to apply different signal processes to the left and right eye video signals based on the control signal of the signal processing controller and the detection result of the correlation detector.

5. The signal processing device of claim 4, wherein the correlation detector delays one of the left and right eye video signals by a predetermined period of time and calculates a difference between the delayed one of the left and right eye video signals and the other of the left and right eye video signals to detect a correlation between the left and right eye video signals, and outputs the result of the detection.

6. The signal processing device of claim 4, wherein the signal processor includes
a left eye noise reducer configured to reduce a noise component of the left eye video signal, and
a right eye noise reducer configured to reduce a noise component of the right eye video signal.

7. The signal processing device of claim 4, wherein the signal processor includes
a left eye enhancer configured to enhance a predetermined signal component of the left eye video signal, and
a right eye enhancer configured to enhance a predetermined signal component of the right eye video signal.

8. The signal processing device of claim 4, wherein the signal processor applies a first signal process to the left and right eye video signals in a region where the correlation detector has detected a high correlation, and applies a second signal process to the left and right eye video signals in a region where the correlation detector has not detected a high correlation.

9. The signal processing device of claim 8, wherein the signal processor includes
a first left eye noise reducer configured to reduce a noise component of the left eye video signal in a region where the correlation detector has detected a high correlation,
a first right eye noise reducer configured to reduce a noise component of the right eye video signal in a region where the correlation detector has detected a high correlation,
a second left eye noise reducer configured to reduce a noise component of the left eye video signal in a region where the correlation detector has not detected a high correlation, and
a second right eye noise reducer configured to reduce a noise component of the right eye video signal in a region where the correlation detector has not detected a high correlation.

10. The signal processing device of claim 8, wherein the signal processor includes
a first left eye enhancer configured to enhance a predetermined signal component of the left eye video signal in a region where the correlation detector has detected a high correlation,
a first right eye enhancer configured to enhance a predetermined signal component of the right eye video signal in a region where the correlation detector has detected a high correlation,
a second left eye enhancer configured to enhance a predetermined signal component of the left eye video signal in a region where the correlation detector has not detected a high correlation, and
a second right eye enhancer configured to enhance a predetermined signal component of the right eye video signal in a region where the correlation detector has not detected a high correlation.

11. A signal processing device for processing a stereoscopic video signal including a left eye video signal and a right eye video signal, comprising:
a correlation detector configured to detect a correlation between the left and right eye video signals and output a result of the detection; and
a signal processor configured to apply a signal process to the left and right eye video signals in a region where the correlation detector has detected a high correlation between the left and right eye video signals, and not to apply a signal process to the left and right eye video signals in a region where the correlation detector has not detected a high correlation between the left and right eye video signals.

12. The signal processing device of claim 11, wherein the correlation detector delays one of the left and right eye video signals by a predetermined period of time and calculates a difference between the delayed one of the left and right eye video signals and the other of the left and right eye video signals to detect a correlation between the left and right eye video signals, and outputs the result of the detection.

13. The signal processing device of claim 11 or 2, wherein the signal processor includes
a left eye noise reducer configured to reduce a noise component of the left eye video signal in a region where the correlation detector has detected a high correlation, and
a right eye noise reducer configured to reduce a noise component of the right eye video signal in a region where the correlation detector has detected a high correlation,

14. The signal processing device of claim 11 or 12, wherein the signal processor includes
a left eye enhancer configured to enhance a predetermined signal component of the left eye video signal in a region where the correlation detector has detected a high correlation, and
a right eye enhancer configured to enhance a predetermined signal component of the right eye video signal in a region where the correlation detector has detected a high correlation.
